(19) United States
(12) Patent Application Publication
(10) Pub. No.: US 2024/0303697 A1
(43) Pub. Date: Sep. 12, 2024

(54) INFORMATION PROCESSING METHOD, PROTECTIVE CASE FOR COLLECTIBLE, AND INFORMATION PROCESSING SYSTEM

(71) Applicant: IPDefine Ltd., Tokyo (JP)

(72) Inventors: Mitsuhiro OKAMOTO, Tokyo (JP); Haruki MARUMO, Tokyo (JP)

(73) Assignee: IPDefine Ltd., Tokyo (JP)

(21) Appl. No.: 18/590,079

(22) Filed: Feb. 28, 2024

(30) Foreign Application Priority Data
Mar. 7, 2023 (JP) 2023-034718

(51) Int. Cl. G06Q 30/02; G06Q 20/36; G06Q 20/38

(52) U.S. Cl. CPC G06Q 30/0278; G06Q 20/3672; G06Q 20/38215; G06Q 20/3829; G06Q 20/389

(57) ABSTRACT

An information processing method is provided. The information processing method includes broadcasting a creation request to a blockchain network to create a non-fungible token (NFT) associated with a tangible object on a blockchain. The blockchain network is composed of a plurality of nodes. Each of the nodes has the blockchain. The non-fungible token is associated with appraisal information indicating an appraisal of the tangible object and attribute information of the tangible object.

This application claims priority from Japanese Patent Application No. 2023-034718, filed on Mar. 7, 2023, the entire contents of which are hereby incorporated by reference.

### BACKGROUND

### Technical Field

The present disclosure relates generally to an information processing method, a protective case for collectible, and an information processing system. In particular, the present disclosure relates primarily to non-fungible tokens (NFTs) associated with tangible objects such as collectibles.

### Background Art

In recent years, the secondary market for trading collectibles such as trading cards has become more active. For example, some Pokémon cards (registered trademark), which are very popular as trading cards, sell for high prices of several million yen in the trading card marketplace. Furthermore, as disclosed in Non-Patent Document 1, platforms that treat trading cards as a new investment product as an alternative to financial assets have emerged in recent years. In addition, as disclosed in Non-Patent Document 2, an appraiser that appraises and evaluates trading cards and other collectibles plays a major role in the marketplace in view of ensuring the safety of trading card transactions in the secondary market. In this regard, appraisal on a trading card performed by the appraiser gives a great impact on the asset value of the trading card. In particular, the market value (assert value) of the trading card fluctuates significantly depending on the appraisal on the trading card.
Non-Patent Document 1: “Joint Ownership Platform for Collecting Rare Collectibles from 1,000 yen”, alty, Inc., [retrieved on Feb. 23, 2023], URL: https://myalty.jp
Non-Patent Document 2: “PSA Japan: PSA Grading and Appraisal in Japan”, Collectors Universe, Inc., [retrieved on Feb. 23, 2023], URL: www.psacard.co.jp

By the way, appraisal information on collectibles, which are tangible objects, is actually centrally managed in a database on a server. For example, an appraiser appraises a trading card and then registers the appraisal information (e.g., card grade information) on the trading card in the database. The appraiser then returns the trading card to an owner of the trading card after enclosing it inside a special card protective case with the appraisal certification number. The owner can check the attribute and appraisal information of the trading card by entering the appraisal certification number displayed on the card protective case on a website managed by the appraiser (see, for example, Non-Patent Document 2).

However, in the current situation where the market price of trading cards is soaring in the secondary market, it is not preferable that the appraisals of trading cards, which have a significant impact on the asset value of trading cards, are managed centrally on a database. For example, the database managed by the appraiser could be tampered with by a cyber attack from a third party. In particular, the grade information for each trading card registered on the database could be falsified. Furthermore, the card protective case that encloses the trading card could be counterfeited. In particular, as a result of falsification of the appraisal certificate number displayed on the card protective case, purchasers may purchase the trading card based on the appraisal associated with the falsified appraisal certificate number. As a result, purchasers and investors who buy trading cards may suffer significant financial losses. Thus, it is difficult to say that the security of transactions in collectibles such as trading cards is adequately ensured at present.

Also known are platforms that divide the ownership of a collectible such as a trading card into multiple co-ownership interests and then sell the divided multiple co-ownership interests to investors (see, for example, Non-Patent Document 1). However, it is difficult for investors to verify whether the platformer own the actual collectible for investment. This requires the investors to purchase co-ownership interests in the collectible on the basis of trust in the platformer. Thus, it is difficult to say that the safety of transactions in investment products associated with collectibles is also adequately ensured at present.

### SUMMARY

The present disclosure provides an information processing method, a protective case for collectible, and an information processing system that can sufficiently ensure the safety of transactions of a tangible object such as a collectible and an investment product associated with the tangible object.

According to an aspect of the present disclosure, an information processing method implemented by a computer is provided. The method includes: obtaining attribute information of a tangible object; obtaining appraisal information indicating an appraisal of the tangible object; sending the appraisal information and the attribute information to outside; and broadcasting a creation request to a blockchain network to create a non-fungible token associated with the attribute information and the appraisal information on a blockchain. The blockchain network is composed of a plurality of nodes each having the blockchain. The non-fungible token is created on the blockchain. The appraisal information and the attribute information is recorded as metadata for the non-fungible token.

### BRIEF DESCRIPTION OF THE DRAWINGS

For a better understanding of the nature and objects of an embodiment of the present disclosure, reference should be made to the following detailed description taken in conjunction with the accompanying drawings, in which:

FIG. 1 illustrates an example configuration of an information processing system according to an embodiment of the present disclosure (hereinafter referred to as “the present embodiment”).

FIG. 2 illustrates an example hardware configuration of an appraiser device.

FIG. 3 illustrates an example hardware configuration of a user device.

FIG. 4 is a sequence diagram illustrating a series of processes of creating a non-fungible token (NFT) associated with a trading card.

FIG. 5A illustrates the front surface of the trading card to explain the evaluation index of the trading card.

FIG. 5B illustrates the back surface of the trading card to explain the evaluation index of the trading card.

FIG. 6 illustrates an example configuration of the NFT associated with the trading card.

FIG. 7 is a schematic diagram showing the trading card enclosed in a protective case.

FIG. 8 is a flowchart illustrating a series of processes of automatically determining information associated with the trading card based on image data showing the trading card.

FIG. 9 illustrates an example configuration of the information processing system according to the present embodiment, and shows how a trading card and an NFT associated with the trading card are transferred from one user to the other.

FIG. 10 is a sequence diagram to explain a series of processes of displaying information related to the trading card on the user device and a series of processes of changing the owner of the NFT from one user to the other.

FIG. 11 illustrates an example configuration of an information processing system according to a variation of the present embodiment, and shows how NFTs associated with a trading card are transferred to users.

FIG. 12 is a sequence diagram illustrating a series of processes of transferring NFTs to users, wherein each of the NFTs represents a co-ownership interest in the trading card.

FIG. 13 illustrates an example of an NFT management table stored in an NFT exchange database.

FIG. 14 illustrates an example of the NFT trading board screen.

### DETAILED DESCRIPTION

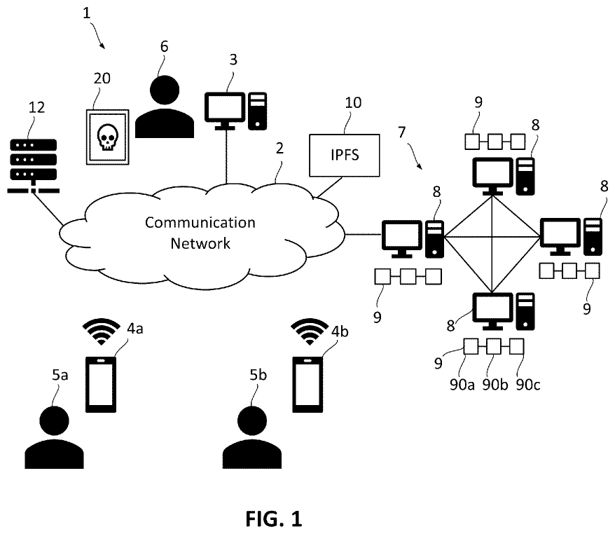

In the following description of the disclosure and examples, an information processing system 1 according to the present embodiment will be described with reference to the drawings. FIG. 1 illustrates an example configuration of the information processing system 1 according to the present embodiment. As shown in FIG. 1, the information processing system 1 includes but not limited to an appraiser device 3, a web server 12, user devices 4a, 4b, a blockchain network 7, and an inter planetary file system (IPFS) 10. These elements of the information processing system 1 are communicatively connected to each other via a communication network 2. In particular, the appraiser device 3 and the user devices 4a, 4b are communicatively connected to the blockchain network 7 via the communication network 2.

The communication network 2 includes at least one of Local Area Network (LAN), Wide Area Network (WAN), Internet, and wireless core network, for example. In the following description, the user devices 4a and 4b may be referred to collectively as simply “user device 4”. A user 5a, who operates the user device 4a, and a user 5b, who operates the user device 4b, may be referred to collectively as simply “user 5”.

The appraiser device 3 is a computer device operated by an appraiser 6 that appraises and evaluates collectibles such as trading cards. That is, the appraiser device 3 is a device associated with the appraiser 6. The type of the appraiser device 3 is not limited to any particular type. The appraiser device 3 may be a personal computer, smartphone, tablet or server. In the present embodiment, it is assumed that the user 5a requests the appraisal of a trading card 20 owned by him/her to the appraiser 6. The appraiser 6 shall create a non-fungible token (NFT) associated with the trading card 20 after appraising the trading card 20. Here, NFT means a unique and non-fungible token that is recorded on a blockchain 9. The NFT associated with the trading card 20 also indicates the owner of the trading card 20 externally.

In a current situation where trading of collectibles such as trading cards in the secondary market is gaining prominence as a new investment product, the appraiser 6 that appraises the asset value of collectibles are playing an important role in the secondary market. In the description of the present embodiment, trading cards will be described as an example of tangible objects subject to appraisal by the appraiser 6, but the types of tangible objects subject to appraisal are not limited to any particular type. For example, other examples of tangible objects subject to appraisal by the appraiser 6 may be real estate, used cars, other collectibles other than trading cards, etc. Examples of collectibles other than trading cards may be toys, retro games, antique coins, artwork (paintings, prints, posters, figurines, etc.), used brand-name items (accessories, watches, bags, etc.), used books (manga, novels, etc.). Thus, the tangible objects according to the present embodiment may be any tangible objects that are subject to secondary market transactions. On the other hand, the present embodiment does not cover intangible objects such as digital artwork.

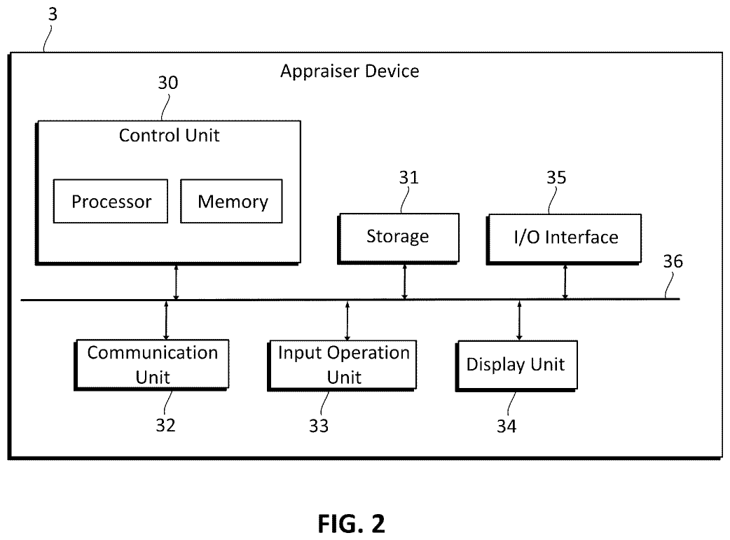

Next, the hardware configuration of the appraiser device 3 will be described below with reference to FIG. 2. As shown in FIG. 2, the appraiser device 3 includes but not limited to a control unit 30, a storage 31, a communication unit 32, an input operation unit 33, a display unit 34, and an input/output (I/O) interface 35. These elements of the appraiser device 3 are connected to a communication bus 36.

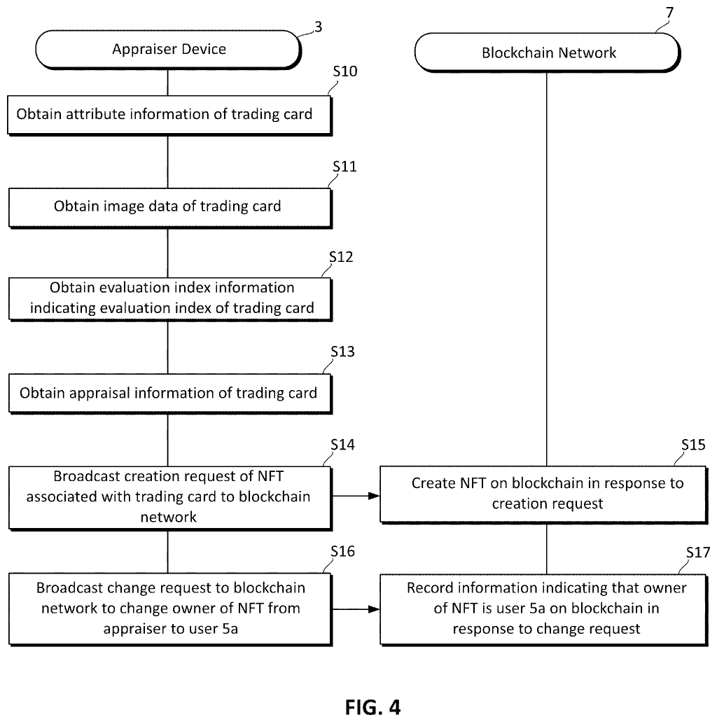

The control unit 30 has a memory and a processor. The memory is configured to store computer readable instructions (programs). For example, the memory includes ROM (Read Only Memory) in which various programs are stored and RAM (Random Access Memory) with multiple work areas in which various programs executed by the processor are stored. The various programs may include information processing programs that execute the information processing method according to the present embodiment (in particular, the series of processes shown in FIGS. 4, 8, and 12). The processor may include at least one of CPU (Central Processing Unit), MPU (Micro Processing Unit) and GPU (Graphics Processing Unit), for example. The CPU may include multiple CPU cores. The GPU may include multiple GPU cores. The processor may be configured to expand on RAM the programs specified from the various programs installed in the storage 31 or ROM and to execute various processes in cooperation with RAM. In particular, the processor may execute the series of information processing described below by expanding the information processing programs installed in the storage 31 or ROM onto RAM.

The storage 31 may be a hard disk drive (HDD), solid state drive (SSD), or flash memory, and is configured to store programs and various data therein. The communication unit 32 includes, for example, a wired communication module and/or a wireless communication module for communicating with external devices connected to the communication network 2. The input operation unit 33 is, for example, a touch panel, mouse, and/or keyboard, and is configured to accept input operations by the appraiser 6 and to generate operation signals in response to the input operations by the appraiser 6. The display unit 34 includes a video display, such as an LCD or organic EL display, and a video display circuit that drives and controls the video display. The I/O interface 35 is an interface that enables connection between an external device and the appraiser device 3, and includes interfaces according to a communication standard such as the USB standard and the HDMI (registered trademark) standard.

Returning to FIG. 1, the web server 12 is a server managed by the appraiser 6. The web server 12 sends data (e.g., HTML files, CSS files, program files, etc.) for displaying an appraisal screen on a web browser of the user device 4 in response to an access request from the user device 4. Here, the appraisal screen shows the appraisal results of the trading card 20. For example, when the web server 12 receives an access request from the user device 4a indicating the appraisal number of the trading card 20, the web server 12 sends data to display an appraisal screen showing the appraisal results of the trading card 20 on the web browser of the user device 4a. The appraisal screen is then displayed on the web browser of the user device 4a. The attribute information, evaluation index information, appraisal information, image data and appraisal number of the trading card 20 may be displayed on the appraisal screen. The above information will be described below.

The user device 4a (an example of a first device) is a device operated by the user 5a (an example of a first user). That is, the user device 4a is associated with the user 5a. The user device 4b (an example of a second device) is a device operated by the user 5b (an example of a second user). That is, the user device 4b is associated with the user 5b. In the present embodiment, the user devices 4a and 4b have the same configuration.

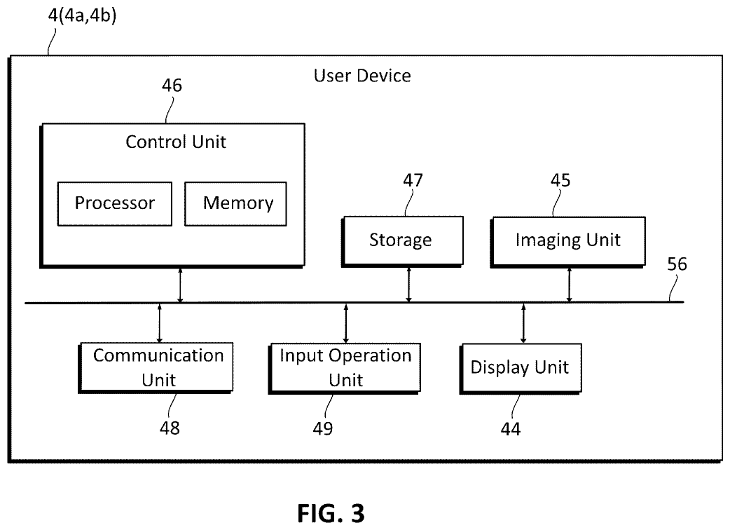

Next, the hardware configuration of the user device 4 will be described below with reference to FIG. 3. As shown in FIG. 3, the user device 4 includes but not limited to a control unit 46, a storage 47, a communication unit 48, an input operation unit 49, a display unit 44, and an imaging unit 45. These elements of the user device 4 are connected to a communication bus 56. In the present embodiment, the user device 4 is described as a portable device, but the type of the user device 4 is not limited thereto. For example, the user device 4 may be a smartphone, personal computer, tablet or wearable device.

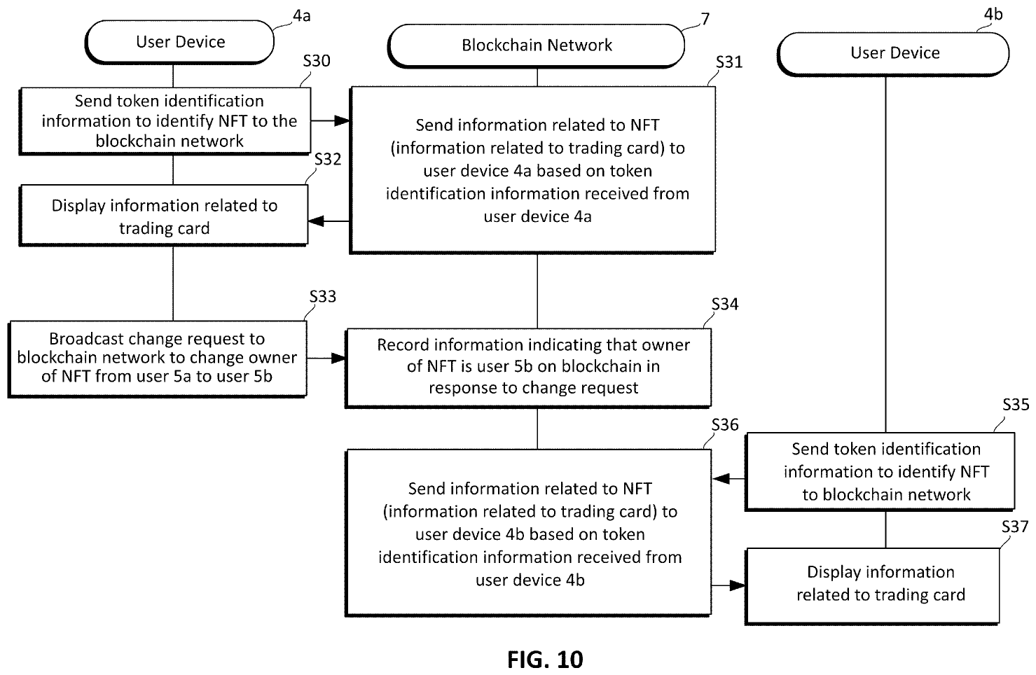

The control unit 46 has a memory and a processor. The memory includes a ROM in which various programs are stored and a RAM in which various programs executed by the processor are stored. The various programs may include information processing programs that execute the information processing method according to the present embodiment (in particular, the series of processes shown in FIG. 10). The processor may include at least one of CPU, MPU and GPU, for example. The processor may be configured to expand on RAM the programs specified from the various programs installed in the storage 47 or ROM and to execute various processes in cooperation with RAM. In particular, the processor may execute the series of information processing described below by expanding the information processing programs installed in the storage 47 or ROM onto RAM.

The storage 47 is, for example, a NAND flash memory, HDD or SSD. The communication unit 48 includes a wireless communication module for communicating with external devices connected to the communication network 2. The input operation unit 49 is, for example, a touch panel superimposed on a video display of the display unit 44, and is configured to accept input operations of the user 5 and to generate operation signals in response to the input operations of the user 5. The display unit 44 includes a video display and a video display circuit that drives and controls the video display, for example.

The imaging unit 45 is configured to capture images or videos showing the environment surrounding the user device 4. In particular, the imaging unit 45 is configured to generate image or video data showing the environment surrounding the user device 4, and may include an image sensor (e.g., CCD sensor or CMOS sensor) and an image sensor drive processing circuitry.

Returning to FIG. 1, the blockchain network 7 is a P2P (Peer to Peer) type network (in other words, a distributed network) that is composed of multiple nodes 8. Each node 8 has a blockchain 9. Each node 8 is directly or indirectly connected to another node 8. The blockchain 9 is a type of distributed ledger technology (DLT), and the blockchain 9 stored in each node 8 has the same ledger information.

The blockchain 9 differs from centralized databases built on servers in terms of decentralization, tamper resistance, persistence, transparency, and smart contracts. The blockchain 9 includes multiple blocks. Each block is connected by blocks generated before and after it in time. Each block has information on multiple transactions and block header information. The block header information may include a timestamp, the hash value of the block header of a block generated immediately before in time, and the hash value of the multiple transactions. The block header information may further include a nance value, which makes the first N digits (N>1) of the hash value of the block header 0.

Specifically, as shown in FIG. 1, a block 90b is connected to a block 90a, which was generated immediately before in time, and a block 90c, which was generated immediately after in time. Specifically, the block 90b has information on multiple transactions and block header information. The block header information of the block 90b includes the hash value of the block header of the block 90a, the timestamp, and the hash value of the multiple transactions in the block 90b. The block 90c has information on multiple transactions and block header information. The block header information of the block 90c includes the hash value of the block header of the block 90b, the timestamp, and the hash value of the multiple transactions in the block 90c. Thus, each block 90a to 90c is temporally associated with other blocks generated immediately before and after it via the hash value of the block header of the other blocks. Therefore, in the blockchain 9, if some transactions are tampered with, the hash value of the block header is changed. Since each block is linked in a chain by the hash value of the block header of the previous and following blocks, it is extremely difficult to tamper with the data in each block (in particular, the transaction information). In addition, although the three blocks 90a to 90c are illustrated in FIG. 1 for convenience of explanation, the number of blocks created on the blockchain 9 is not limited.

In the present embodiment, the blockchain network 7 may be a public type blockchain network without any administrator, or it may be a private type blockchain network with an administrator. The consensus algorithm of the blockchain network 7 may be a PoS (Proof of Stake) or a PoW (Proof of Work).

The blockchain 9 is a blockchain with smart contract capabilities. Smart contracts are program code to execute automated contracts and transactions recorded on the blockchain 9. Each node 8 executes smart contracts recorded (deployed) on the blockchain 9 and also verifies the results of smart contract execution. Thus, smart contracts can automatically execute transactions and contracts recorded on the blockchain 9 without any middleman. According to the present embodiment, in the case where an NFT is created on the blockchain 9, the smart contract associated with the NFT (NFT contract) is recorded on the blockchain 9.

Ethereum may be employed as the blockchain network 7, or blockchain networks with smart contract capabilities other than Ethereum (e.g., Tron, Binance Smart Chain (BSC), Avalanche, Solana, Algorand, Astar, and other L1 projects, and Polygon, Arbitrum, Optimism, and other L2 projects) may be employed. When the blockchain network 7 is Ethereum, the EVM (Ethereum Virtual Machine) in each node 8 executes smart contracts deployed on the blockchain 9 an then verifies the results of smart contract execution.

The IPFS 10 is a distributed storage service that runs on a P2P network. In the present embodiment, the image data and metadata of the trading card 20 may be stored on the IPFS 10 as described below. The image data and metadata may be stored on a data server connected to the communication network 2 instead of the IPFS 10.

With reference to FIG. 4, a series of processes of creating an NFT associated with the trading card 20 (in other words, an NFT indicating an owner of the trading card 20) will be described below. FIG. 4 is a sequence diagram illustrating a series of processes of creating the NFT associated with the trading card 20. In this example, it is assumed that the user 5a, who owns the trading card 20, requests the appraisal of the trading card 20 and the creation of the NFT associated with the trading card 20 to the appraiser 6.

As shown in FIG. 4, in step S10, the appraiser device 3 (more specifically, the control unit 30 of the appraiser device 3) obtains the attribute information of the trading card 20 (hereinafter simply referred to as “card 20”) in response to an input operation by the appraiser 6. More specifically, the appraiser 6 enters the attribute information of the card 20 into the appraiser device 3 via the input operation unit 33. The attribute information of the card 20 may include, for example, information about the date of manufacture, brand name, and item name of the card 20.

Next, in step S11, the appraiser device 3 obtains the image data of the card 20 in response to the input operation by the appraiser 6. For example, the appraiser 6 takes a picture of the card 20 using a camera (not shown). The appraiser 6 then captures the image data showing the card 20 into the appraiser device 3 using a USB memory or other storage medium.

The camera may be connected to the appraiser device 3 via the I/O interface 35. The appraiser device 3 may also have a camera function. The image data of the card 20 may be still image data of the card 20 or moving image data of the card 20. In case of moving image data, it is preferable to capture at least the front and back surfaces of the card 20.

In step S12, the appraiser device 3 obtains the evaluation index information indicating the evaluation index of the card 20 in response to an input operation by the appraiser 6. More specifically, the appraiser 6 carefully observes the state of the card 20 and then inputs the evaluation index information of the card 20 to the appraiser device 3 via the input operation unit 33.

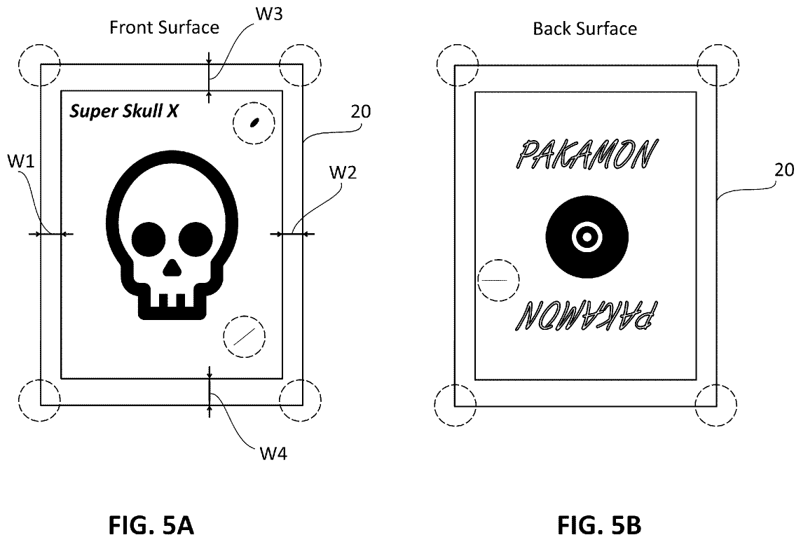

The evaluation index information of the card 20 may include evaluation index information indicating the preservation state of the card 20 and the initial state of the card 20. For example, the evaluation index information indicating the state of preservation of the card 20 may include information indicating the degree of scratches (e.g., scrapes, scratches, dents, defects, etc.) on the front surface of the card 20, information indicating the degree of dirt or stains on the front surface of the card 20, and information indicating the state of the four corners of the card 20 (see FIG. 5). The information indicating the state of the four corners of the card 20 may include information indicating that the four corners of the card 20 are sharp (in other words, information indicating that there is no wear on the four corners) and information indicating that the four corners are not damaged. In addition, the evaluation index information indicating the preservation state of the card 20 may further include the following information:

Information indicating the degree of gloss on the front surface of the card 20 (in other words, information indicating the degree of wear on the front surface of the card 20);
Information indicating the degree of wrinkling of the card 20;
Information indicating the degree of warping or twisting of the card 20;
Information indicating the loss of the glossing agent applied to the card 20; and
Information indicating the degree of discoloration or tanning of the card 20;

As shown in FIG. 5, on the front surface of the card 20, the scratches, stains, and four corners of the card 20 are indicated by circular areas surrounded by dashed lines. The evaluation index information indicating the initial state of the card 20 may include information indicating the degree of cutting (centering) of the card 20, the degree of printing (ink loss or ink skipping) of the card 20, and the degree of out-of-focus of the card 20. On the back surface of the card 20 shown in FIG. 5, the ink loss on the card 20 is indicated by a circular area surrounded by a dashed line.

For example, as shown in FIG. 5, if the dimensional difference between the frame width W1 on the left side of the card 20 and the frame width W2 on the right side of the card 20 is large, and the dimensional difference between the frame width W3 on the top of the card 20 and the frame width W4 on the bottom of the card 20 is large, the cutting state (centering) of the card 20 is evaluated to be poor. On the other hand, if the dimensional difference between the frame widths W1 and W2 is small and the dimensional difference between the frame widths W3 and W4 is small, the cutting state (centering) of the card 20 is evaluated to be good. Thus, the information indicating the degree of cutting state of the card 20 may include centering criteria information related to the degree of dimensional difference between the frame widths W1 and W2 of the card 20 and the degree of dimensional difference between the frame widths W3 and W4 of the card 20. The degree of printing state of the card 20 is determined according to the presence or absence of ink loss or ink skipping on the card 20.

Next, in step S13, the appraiser device 3 obtains appraisal information indicating the appraisal of the card 20 in response to an input operation by the appraiser 6. More specifically, the appraiser 6 comprehensively determines the appraisal information of the card 20 based on the evaluation index information, and then inputs the appraisal information of the card 20 to the appraiser device 3 via the input operation unit 33.

The appraisal information of the card 20 may include grade information indicating the grade of the card 20. For example, the card 20 may be classified by 10 grades from 1 to 10 or 4 grades from S, A, B, and C. In this case, the highest grade of the card 20 is 10 or S. The lowest grade of the card 20 is 1 or C. If the card 20 is counterfeit or restored, the appraisal information may include information indicating that the card 20 is counterfeit or the card 20 has been restored. In addition, the appraisal information of the card 20 may further include information regarding the appraised value of the card 20.

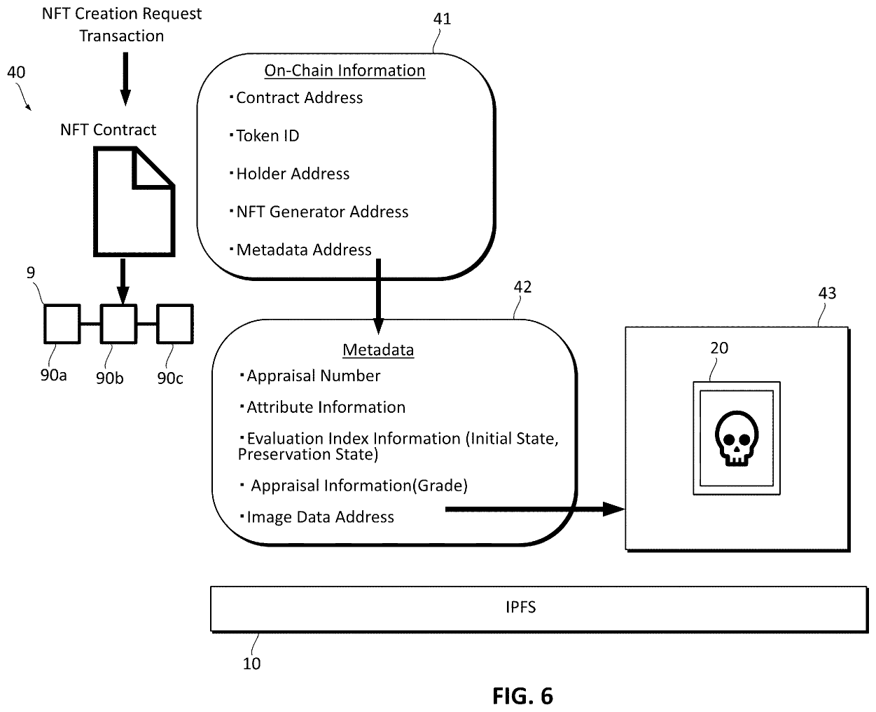

Then, in step S14, the appraiser device 3 broadcasts a creation request of the NFT associated with the card 20 (creation request transaction) to the blockchain network 7 in response to an input operation of the appraiser 6. In this case, as shown in FIG. 6, the appraiser device 3 broadcasts the image data 43 of the card 20 and a set of information associated with the card 20 (specifically, appraisal number, attribute information, evaluation index information, and appraisal information) to the IPFS 10. The image data 43 of the card 20 may be still or moving image data, as described above. The set of information associated with the card 20 may be stored on the IPFS 10 as metadata 42. Here, the metadata 42 of the card 20 includes the appraisal number created by the appraiser 6, the attribute information, the evaluation index information, the appraisal information of the card 20, and the address (URL) of the image data 43.

If Ethereum is employed as the blockchain network 7, the NFT 40 may be a token compatible with the ERC721 standard. In step S15, the blockchain network 7 receives the creation request of the NFT 40 from the appraiser device 3 and then creates the NFT 40 on the blockchain 9 in response to the creation request. Specifically, as shown in FIG. 6, each node 8 that is composed of the blockchain network 7 records the smart contract associated with the NFT 40 (NFT contract) on the blockchain 9 in response to the creation request transaction of the NFT 40. The on-chain information 41 contained in the NFT contract may include a contract address, a token ID, a holder address (wallet address of the holder), an NFT generator address (wallet address of the NFT generator), and a metadata address (URI).

In the present embodiment, each NFT created by the appraiser 6 may be tied to a certain contract address. That is, the contract address of the NFT 40 may be a unique contract address tied to the appraiser 6. In this case, a third party can clearly recognize that the NFT 40 has been created by the appraiser 6 by checking the contract address of the NFT 40. In this case, the token ID of a new NFT may be changed when the appraiser 6 creates the new NFT using its own contract address associated with the appraiser 6. For example, if the NFT is the 230th created, the token ID may be 229. If the NFT is the 231st created, the token ID may be 230. Thus, the combination of the contract address and token ID makes each NFT a unique token, which is different from fungible tokens (FTs). Each time the NFT 40 is newly created, a new contract address of the NFT 40 may be issued. In this case, a third party is not able to clearly recognize that the NFT 40 has been created by the appraiser 6 even by checking the contract address of the NFT 40.

The holder address of the NFT is the wallet address held by the appraiser 6. If Ethereum is employed as the blockchain network 7, the wallet address held by the appraiser 6 will consist of 42 alphanumeric digits beginning with “0x”. In this regard, the appraiser device 3 may create a wallet address for the appraiser 6 based on a public key associated with a public electronic certificate associated with the appraiser 6 (e.g., an electronic certificate of commercial registration created by the Legal Affairs Bureau) and a certain hash function (e.g., SHA-256). In this case, it can be made objectively clear that the wallet address is owned by the appraiser 6. Furthermore, the appraiser 6 digitally signs transactions using the private key associated with the public digital certificate so as to transfer digital assets (including FTs and NFTs) recorded on the blockchain 9.

The generator address of the NFT is also the wallet address held by the appraiser 6. Even if the NFT 40 is transferred from the appraiser 6 to another party, the generator address remains unchanged. The metadata address is a link address for specifying the metadata stored on the IPFS 10. The metadata address (URI) is specified so that the metadata of the NFT 40 can be obtained from the IPFS 10.

Thus, the NFT 40 has the on-chain information 41 recorded on the blockchain 9 and is directly associated with the metadata 42 via the metadata addresses (URI). The NFT 40 is indirectly associated with the image data 43 showing the card 20 via the metadata address and the address of the image data 43 contained in the metadata 42. When Ethereum is used as the blockchain network 7, the NFT 40 may be an off-chain NFT in order to save transaction fees (so-called gas fees) caused by transactions related to the NFT 40. In other words, the metadata 42 and image data 43 of the NFT 40 are not recorded on the blockchain 9, but are recorded outside the blockchain 9 (in this example, on the IPFS 10).

However, the NFT 40 is not limited to the off-chain NFT, but can also be the on-chain NFT. That is, the metadata of the NFT 40 may be recorded as on-chain information on the blockchain 9. In this case, the NFT 40 is directly associated with the image data 43 showing the card 20 via the address of the image data 43 contained in the on-chain information. The hash value of the metadata may also be recorded as on-chain information on the blockchain 9. In this regard, when each of the attribute information, evaluation index information, and appraisal information of the card 20 is recorded on the blockchain 9, prospective purchasers or investors of the card 20 can reliably confirm the attribute information, evaluation index information, and appraisal information of the card 20 through the attribute information, evaluation index information, and appraisal information with high tamper resistance. Thus, the reliability of the NFT 40 can be further enhanced, which further improves the security of transactions of the card 20 and the investment products associated with the card 20 through the NFT 40.

Returning to FIG. 4, in step S16, the appraiser device 3 broadcasts a change request (change request transaction) to the blockchain network 7 to change the owner of the NFT 40 from the appraiser 6 to the user 5a in response to an input operation of the appraiser 6. Here, it is assumed that the user 5a has provided information regarding his/her wallet address of the user 5a to the appraiser 6 in advance. In this regard, attribute information about the user 5a, including the wallet address of the user 5a, may be recorded on a user database managed by the appraiser 6.

In step S17, the blockchain network 7 receives the change request to change the owner of the NFT 40 from the appraiser device 3, and then records information indicating that the owner of the NFT 40 is the user 5a on the blockchain 9 in response to the change request. In particular, each node 8 of the blockchain network 7 records information indicating that the owner of the NFT 40 is the user 5a on the blockchain 9 by calling the NFT contract recorded on the blockchain 9 in response to the change request. The appraiser 6 may execute the process of step S16 after confirming the receipt of appraisal fees from the user 5a. Thus, the appraiser 6 performs the appraisal of the card 20 and creates the NFT 40 associated with the appraisal information of the card 20. The appraiser 6 then changes the owner of the NFT 40 from the appraiser 6 to the user 5a.

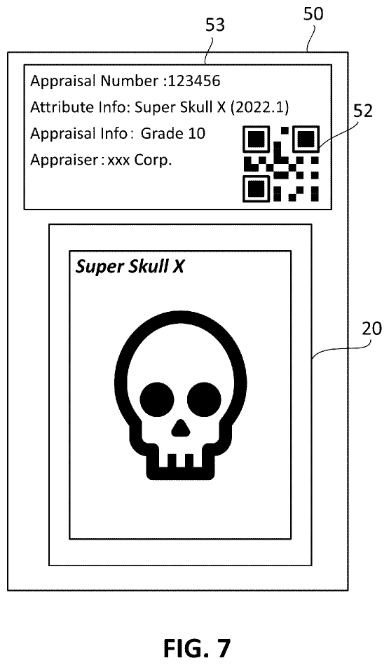

Furthermore, after creating the NFT 40, the appraiser 6 encloses the card 20 in a protective case 50 configured to house the card 20 therein (see FIG. 7). The appraiser 6 then returns the card 20 enclosed in the protective case 50 to the user 5a. As shown in FIG. 7, a card information label 53 displaying card information associated with the card 20 may be enclosed in the protective case 50 along with the card 20. The protective case 50 may be formed of a transparent resin material, for example. In particular, the card information label 53 and the card 20 may be sealed within the protective case 50 so as to prevent counterfeiting of the card information label 53. The card information label 53 may display, for example, the appraisal number, the attribute and appraisal information of the card 20, the appraiser information, and a two-dimensional (2D) barcode 52. The 2D barcode 52 may have token identification information to identify the NFT 40 associated with the card 20. The token identification information may include the contract address and token ID of the NFT 40. For example, the 2D barcode 52 may include token identification information, domain information of an NFT marketplace (e.g., OpenSea) for buying and selling NFTs. The user 5a can obtain the token identification information of the NFT 40 contained in the 2D barcode 52 by capturing an image of the 2D barcode 52 using the imaging unit 45 of the user device 4a. The user device 4a then transmits the token identification information to the blockchain network 7 to obtain a set of information (e.g., attribute and appraisal information about the card 20) related to the NFT 40 from the blockchain network 7. This process will be described in detail with reference to FIG. 10.

According to this embodiment, the NFT 40 associated with the appraisal information (in particular, grade information) and attribute information of the card 20 is created on the blockchain 9. Thus, the presence of the NFT 40 created on the blockchain 9 makes it possible to adequately secure the transactions of the card 20 and the investment products associated with the card 20. Also, since the NFT 40 is associated with the image data 43 of the card 20, a prospective purchaser of the card 20 can understand that the NFT 40 is associated with the card 20 through the image data 43.

Furthermore, a prospective purchaser of the card 20 or an investor who plans to purchase an investment product associated with the card 20 can confirm the validity of the appraisal of the card 20 conducted by the appraiser 6 through the evaluation index information indicating the preservation state of the card 20 (e.g., scratches or stains on the card surface) and the initial state of the card 20 (e.g., printing errors or cutting errors). Thus, the validity of the appraisals of the card 20 conducted by the appraiser 6 can be made clear and transparent, thereby increasing the transparency and reliability of the appraisal of the card 20. As a result of this, the security of transactions for the card 20 and the investment products associated with the card 20 can be further enhanced.

According to the present embodiment, it is also possible to provide the protective case 50 that can adequately ensure the security of transactions for the card 20 and investment products associated with the card 20. In particular, the owner of the card 20 and the owner of the NFT 40 are linked with each other in a one-to-one relationship. Thus, even if the protective case 50 is counterfeited (in particular, if the 2D barcode 52 displayed on the protective case 50 is falsified), the fraudulent seller cannot change the owner of the NFT 40 corresponding to the falsified token identification information to a prospective purchaser. Thus, through the presence of the NFT 40, it is possible to suitably prevent the fraudulent sale of the card 20 through counterfeiting the protective case 50.

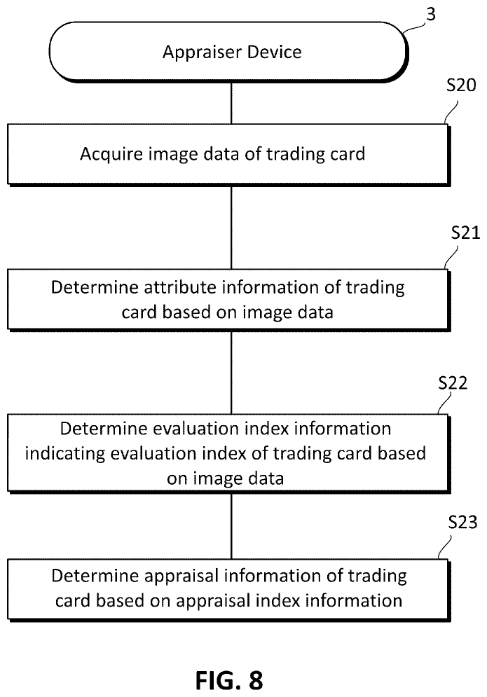

In addition, the order of the steps S10 to S14 shown in FIG. 4 is not particularly limited. Furthermore, in the example shown in FIG. 4, the appraiser device 3 obtains the attribute information, evaluation index information, and appraisal information of the card 20 in response to the input operation of the appraiser 6, but the appraiser device 3 may automatically determine the above information based on the image data. In this regard, a series of processes of automatically determining the various information about the card 20 will be described below with reference to FIG. 8. FIG. 8 is a flowchart illustrating a series of processes of automatically determining information about the card 20 based on image data showing the card 20.

As shown in FIG. 8, in step S20, the appraiser device 3 acquires the image data of the card 20. Next, in step S21, the appraiser device 3 determines the attribute information of the card 20 based on the acquired image data. For example, the appraiser device 3 may determine the attribute information of the card 20 from the image data by referring to a database in which each of image data of multiple cards is associated with a corresponding one of the attribute information of the multiple cards. Alternatively or additionally, the appraiser device 3 may determine the attribute information of the card 20 by extracting textual information of the card 20 displayed in the image data.

Next, the appraiser device 3 determines the evaluation index information of the card 20 based on the image data (step S22). For example, the appraiser device 3 may determine the evaluation index information from the image data based on a machine learning model in which the image data and the evaluation index information are associated with each other. In this case, image data is used as input information for the machine learning model, while evaluation index information is used as output information for the machine learning model. The evaluation index information includes evaluation index information indicating the preservation state of the card 20 and evaluation index information indicating the initial state of the card 20.

In step S23, the appraiser device 3 determines the appraisal information of the card 20 based on the determined evaluation index information. For example, the appraiser device 3 determines appraisal information from the evaluation index information based on table information or a calculation relationship, where the evaluation index information and appraisal information are associated with each other.

According to the processes shown in FIG. 8, after the evaluation index information is determined based on the image data, the appraisal information is determined based on the determined evaluation index information. In other words, since the card 20 is automatically appraised based on the image data of the card 20, it is possible to appropriately prevent a situation in which the appraisal of the card 20 fluctuates greatly depending on appraisers who perform the appraisal. In this way, the transparency and reliability of the appraisal of the card 20 conducted by the appraiser 6 can be further improved.

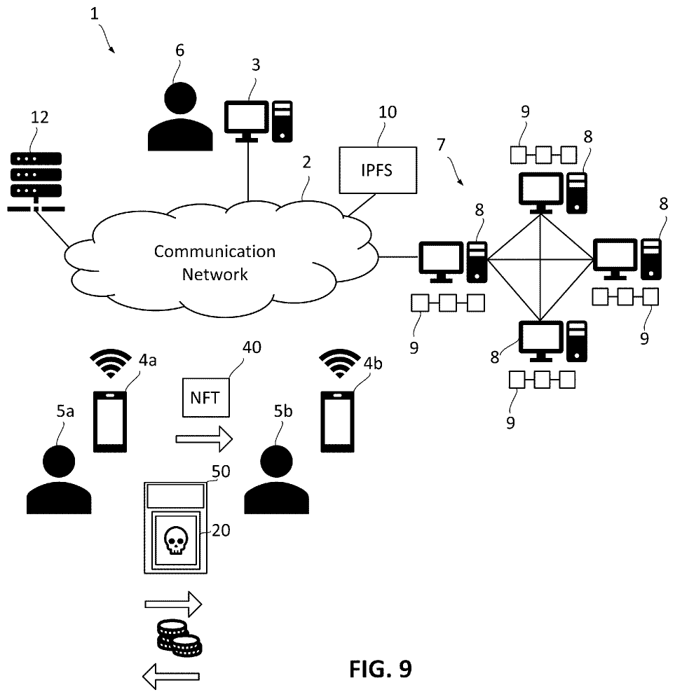

Next, with reference to FIGS. 9 and 10, a series of processes of displaying information related to the card 20 on the user devices 4a and 4b through the NFT 40 and changing the owner of the NFT 40 from the user 5a to the user 5b will be described below. FIG. 9 illustrates an example configuration of the information processing system 1 according to the present embodiment, and shows how the card 20 and NFT 40 are transferred from the user 5a to the user 5b. FIG. 10 is a sequence diagram to explain a series of processes of displaying information related to the card 20 on the user devices 4a and 4b and a series of processes of changing the owner of the NFT 40 from the user 5a to the user 5b. In this example, since the NFT 40 indicates the owner of the card 20, when the card 20 appraised by the appraiser 6 is transferred from the user 5a to the user 5b, the NFT 40 associated with the card 20 shall be transferred from the user 5a to the user 5b as well. Furthermore, when purchasing the card 20 from the user 5a, the user 5b shall pay the user 5a an amount equivalent to the selling price of the card 20 in legal tender (e.g., Japanese yens or US dollars) or cryptocurrency (e.g., ETH or ERC20 standard tokens).

As shown in FIG. 10, in step S30, the user device 4a sends token identification information to identify the NFT 40 to the blockchain network 7. The token identification information includes the contract address and token ID of the NFT 40, for example. Next, the blockchain network 7 (in particular, the nodes 8 participating in the blockchain network 7) identifies information related to the NFT 40 (the on-chain information of the NFT 40) from the blockchain 9 based on the token identification information received from the user device 4a, and then sends information related to the NFT 40 to the user device 4a (step S31).

In step S32, the user device 4a displays information related to the card 20 on the browser based on the information related to the NFT 40 received from the blockchain network 7. In particular, the user device 4a obtains the metadata of the NFT 40 from the IPFS 10 based on the metadata address (URI) contained in the information related to the NFT 40 (the on-chain information). The user device 4a also obtains the image data of the NFT 40 based on the image data address contained in the metadata. Thus, the user 5a can confirm information related to the card 20 (the appraisal number, attribute information, evaluation index information, appraisal information of the card 20, image data, owner address of the NFT 40, etc.) displayed on the browser of the user device 4a. In particular, the user 5a can confirm that the owner of the NFT 40 is the user 5a.

In step S33, the user device 4a broadcasts a change request to the blockchain network 7 to change the owner of the NFT 40 from the user 5a to the user 5b. The blockchain network 7 records information indicating that the owner of the NFT 40 is the user 5b on the blockchain 9 in response to the change request from the user device 4a (step S34). In particular, each node 8 participating in the blockchain network 7 records information indicating that the owner of the NFT 40 is the user 5b on the blockchain 9 by calling the NFT contract recorded on the blockchain 9 in response to the change request.

Next, the user 5b, who purchased the card 20 from the user 5a, confirms the information related to the NFT 40 (the information about the card 20) using the user device 4b. Specifically, in step S35, the user device 4b sends token identification information to identify the NFT 40 to the blockchain network 7. Next, the blockchain network 7 (in particular, the nodes 8 participating in the blockchain network 7) identifies information related to the NFT 40 (on-chain information of the NFT 40) from the blockchain 9 based on the token identification information received from the user device 4b, and then sends information related to the NFT 40 to the user device 4b (step S36).

In step S37, the user device 4b displays information related to the card 20 on the browser based on the information related to the NFT 40, which is received from the blockchain network 7. In particular, the user device 4b may receive the metadata of the NFT 40 from the IPFS 10 based on the metadata address contained in the information about the NFT 40, and may also receive the image data of the NFT 40 from the IPFS 10 based on the image data address contained in the metadata. Thus, the user 5b can confirm information related to the card 20 (the appraisal number, attribute information, evaluation index information, appraisal information of the card 20, image data, owner address of the NFT 40, etc.) displayed on the browser of the user device 4b. In particular, the user 5b can confirm that the user 5b is the owner of the NFT 40.

According to the present embodiment, the NFT 40 associated with the appraisal information indicating the appraisal of the card 20 and the attribute information of the card 20 is created on the blockchain 9. Thus, the NFT 40 created on the blockchain 9 makes it possible to adequately secure the transactions of the card 20 and the investment products associated with the card 20. In particular, the user 5b, who plans to purchase the card 20 from the user 5a, can verify that the user 5a owns the NFT 40, and thus confirm that the user 5a is the true owner of the card 20. In addition, the user 5b can reliably confirm the appraisal and attribute information of the card 20 through the appraisal and attribute information indicated by the NFT 40. Furthermore, an investor who plans to purchase an investment product associated with the card 20 can verify that a seller of the investment product owns the NFT 40, and thus confirm that the seller is the true owner of the card 20. The investor can also reliably verify the appraisal and attribute of the card 20 through the appraisal and attribute information presented by the NFT 40.

### Variation of the Present Embodiment

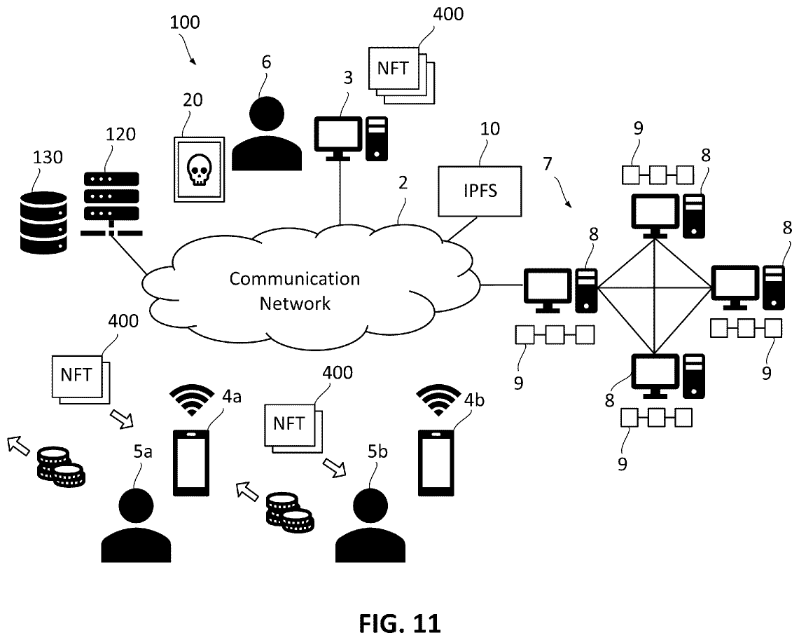

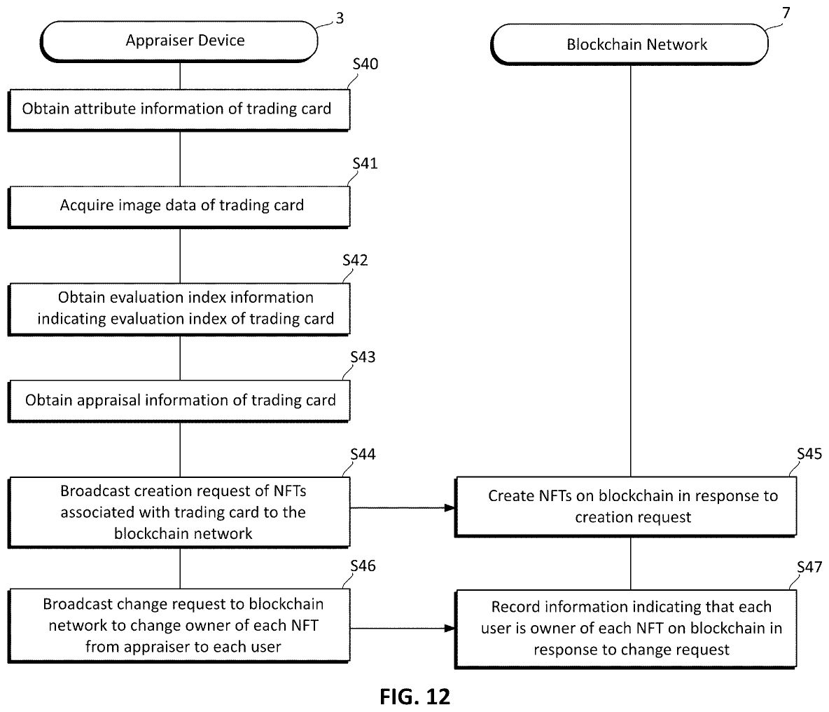

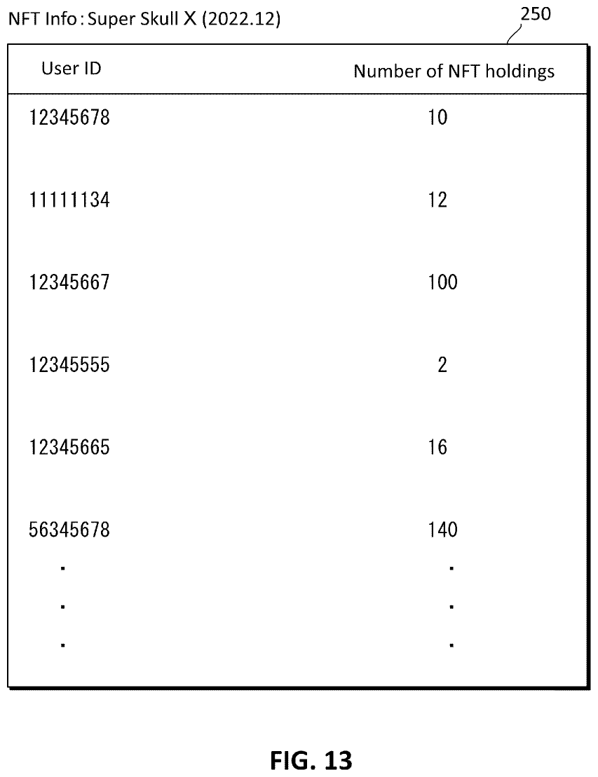

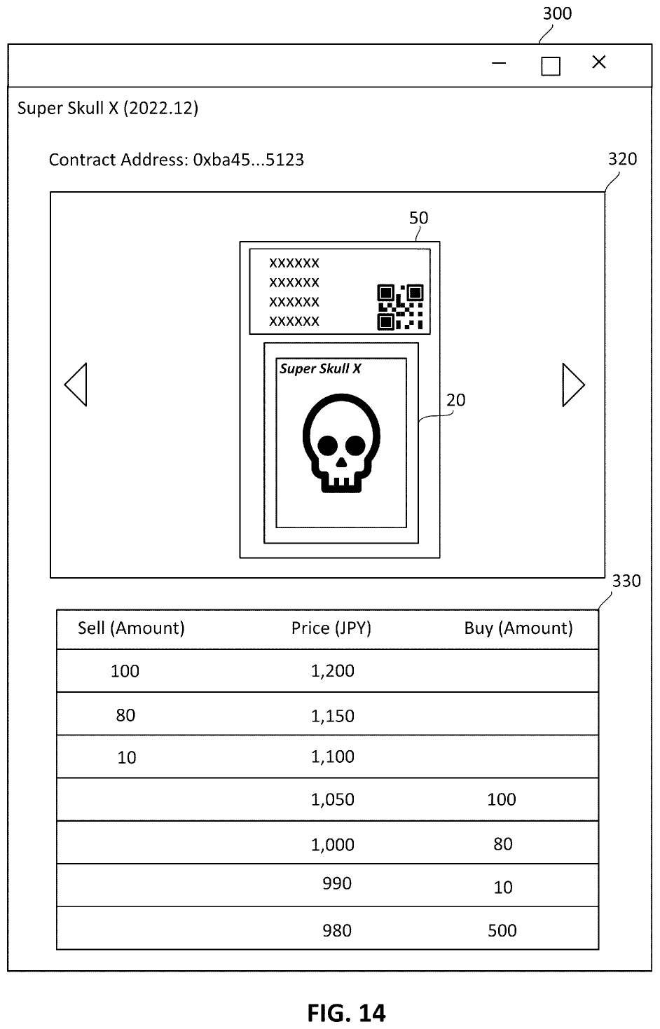

With reference to FIGS. 11 to 14, a variation of the present embodiment will be described. In the following description, the appraiser 6 functions as an NFT exchange where NFTs 400 representing co-ownership interests in the card 20 are sold to users and the NFTs 400 are traded. FIG. 11 illustrates an example configuration of the information processing system 100 according to the variation of the present embodiment, and shows how the NFTs 400 associated with the card 20 are transferred to the users 5a, 5b. FIG. 12 is a sequence diagram illustrating a series of processes of transferring to the NFTs 400 to each user, wherein each NFT 400 represents a co-ownership interest in the card 20. FIG. 13 illustrates an example of an NFT management table 250 stored in an NFT exchange database 130 (see FIG. 11). FIG. 14 shows an example of an NFT trading board screen 300. The information processing system 100 shown in FIG. 11 is different from the information processing system 1 shown in FIG. 1 in that the information processing system 100 has an NFT exchange server 120 and the NFT exchange database 130. In FIG. 11, the users 5a and 5b are shown as some purchasers (investors) of the NFTs 400, but it is assumed that there are many other investors of the NFTs 400 other than the users 5a and 5b. The variation of the embodiment is different from the above embodiment in that the appraiser 6 not only appraises the card 20, but also functions as an exchange of the NFTs 400 while creating the NFTs 400 each indicating the co-ownership of the card 20. The appraiser 6 also serves as a custodian of the card 20 that supports the value of the NFTs 400.

First, a series of processes of creating the NFTs 400 and transferring the created NFTs 400 to each user will be described below with reference to FIG. 12. As shown in FIG. 12, in step S40, the appraiser device 3 (more specifically, the control unit 30 of the appraiser device 3) obtains the attribute information of the card 20 in response to an input operation of the appraiser 6. Next, in step S41, the appraiser device 3 acquires the image data of the card 20 in response to an input operation of the appraiser 6.

In step S42, the appraiser device 3 obtains the evaluation index information indicating the evaluation index of the card 20 in response to an input operation of the appraiser 6. Next, in step S43, the appraiser device 3 obtains appraisal information indicating the appraisal of the card 20 in response to an input operation of the appraiser 6.

Then, in step S44, the appraiser device 3 broadcasts a creation request (creation request transaction) of the NFTs 400 associated with the card 20 to the blockchain network 7 according to an input operation of the appraiser 6. Each of the NFTs 400 has on-chain information and is associated directly or indirectly with the metadata and image data, similar to the NFT 40 shown in FIG. 6. In this regard, each of the NFTs 400 may have a common contract address and a different token ID. For example, if 1000 NFTs 400 are created, the token ID of NFT 400 that was firstly created may be 0, and the token ID of NFT 400 that was 100th created may be 99. Each of the 1000 NFTs 400 may also have a common contract address.

If the value of the card 20 is valued at 1 million yen as a result of an appraisal performed by the appraiser 6, the selling price of each NFT 400 representing the co-ownership interest in the card 20 is 1,000 yen. On the other hand, if the market price of the NFT 400 increases from 1,000 yen to 2,000 yen, the market value of the card 20 is increased to 2 million yen (2,000 yen×1,000 units=2 million yen). In other words, the market price of the NFT 400 corresponds to a stock price, while the market value of the card 20 corresponds to the market capitalization of a corporation issuing the shares. Thus, it is possible to objectively represent the market price (market value) of a tangible object such as the card 20 through the trading of the NFTs 400 which represent the co-ownership interests of the card 20 on the exchange. In particular, the liquidity of tangible objects might not be ensured at all when the tangible objects are of high value. In the meantime, in the variation of the embodiment, the liquidity of the NFTs 400 increases dramatically (i.e., the number of investors participating in transactions of the NFTs 400 increase dramatically) because each NFT 400, which represents a co-ownership interest in a tangible object, is traded on the exchange at a relatively low price. As a result, it is possible to represent the market price of the card 20 which corresponds to an aggregate of the NFTs 400 more accurately.

In the variation of the embodiment, the card 20 is an example of a tangible object, but the higher the price of the tangible object itself, the greater the role of the NFTs 400 which represents co-ownership interests in the tangible object in the marketplace. For example, the liquidity of a used real estate with a sales price of 100 million yen is extremely low. However, if 10,000 NFTs 400 representing co-ownership interests in the used real estate are created, the sales price of each NFT 400 is 10,000 yen. Thus, it is possible to represent an accurate market value of the used real estate through active trading of the NFTs 400 on the exchange. If the tangible object is a used real estate, the appraisal information of the used real estate may include information on the appraised value of the used real estate as assessed by a real estate appraiser and information on the grade of the used real estate. The evaluation index information of the used real estate may include information indicating the state of preservation of the used real estate (in particular, the state of the interior, plumbing, and equipment) and information indicating the initial state of the used real estate (new construction sales price, current road value, sun exposure (direction), risk factors for falling property values, etc.). The evaluation index information may include a variety of information used by real estate appraisers as a basis for appraisal. The same approach using the NFTs 400 can be applied to used cars which are also tangible objects.

Next, in step S45, the blockchain network 7 receives a creation request of the NFTs 400 from the appraiser device 3, and then creates the NFTs 400 on the blockchain 9 in response to the creation request. In step S46, the appraiser device 3 broadcasts a change request (change request transaction) to the blockchain network 7 to change the owner of each NFT 400 from the appraiser 6 to each user in response to an input operation of the appraiser 6. Here, it is assumed that each user has provided information regarding his/her wallet address to the appraiser 6 in advance. In this regard, attribute information about each user, including the user's wallet address, may be recorded on a user database managed by the appraiser 6.

In step S47, the blockchain network 7 receives the change request from the appraiser device 3 to change the owner of each NFT 400, and then records information indicating that each user is the owner of each NFT 400 on the blockchain 9 in response to the change request. In particular, each node 8 of the blockchain network 7 records information indicating that each user is the owner of each NFT 400 on the blockchain 9 by calling the NFT contract recorded on the blockchain 9 in response to the change request. The appraiser 6 may execute the process of step S46 after confirming the receipt of an amount equivalent to the sales price of the NFT 400 from each user. Thus, the appraiser 6 performs the appraisal of the card 20 and creates the NFTs 400 each associated with the appraisal information of the card 20. The appraiser 6 then changes the owner of each NFT 400 from the appraiser 6 to a corresponding one of users.

Each user who has purchased the NFT 400 from the appraiser 6 may then sell the NFT 400 on an exchange managed by the appraiser 6. Users who were unable to purchase the NFT 400 from the appraiser 6 may purchase the NFT 400 on the exchange. In the variation of the present embodiment, the appraiser 6 that appraises the card 20 can create the NFTs 400 associated with the card 20 in a manner similar to an ICO (Initial Coin Offering), etc., and then list the created NFTs 400 on an exchange under its control in a manner similar to an IEO (Initial Exchange Offering), etc. In the variation of the embodiment, the appraiser 6 operates and manages the NFT exchange, but other entities in a business alliance with the appraiser 6 may also operate and manage the NFT exchange.

The appraiser 6 maintains the NFT exchange server 120 and the NFT exchange database 130, as shown in FIG. 11. As shown in FIG. 13, the NFT management table 250 may be stored in the NFT exchange database 130. In the NFT management table 250, the user ID of each user of the exchange and the number of NFTs 400 held by each user are associated with each other. For example, if the user 5a sells two NFTs 400 in his/her possession on the exchange, the user 5a may send the two NFTs 400 to a certain wallet address managed by the exchange. More specifically, the user 5a may broadcast a transaction to change the ownership of the two NFTs 400 from the wallet address of the user 5a to the wallet address of the exchange to the blockchain network 7.

The NFT exchange server 120 also sends the NFT trading board screen 300 to each user device in response to an access request from each user device (see FIG. 14). FIG. 14 shows an example of the NFT trading board screen 300 displayed on the browser of the user device. The NFT trading board screen 300 has an image data display area 320 where the image data of the card 20 is displayed and a trading board area 330. The NFT trading board screen 300 may also show the contract address of the NFT 400. Investors participating in the trading of the NFTs 400 can obtain information related to the NFTs 400 (the appraisal number, attribute information, evaluation index information, appraisal information, image data of the card 20, owner address of the NFTs 400, etc.) from the blockchain network 7 through the contract address of the NFTs 400. In this way, investors can trade the NFTs 400, which represent co-ownership interests in the card 20, with the confidence because they will be able to confirm the information associated with the NFTs 400.

According to the variation of the present embodiment, each of the NFTs 400 created by the appraiser 6 represents a co-ownership interest in the card 20, and thus the NFTs 400 can be treated as investment products representing co-ownership interests in the card 20. In particular, a purchaser of the NFT 400 can reliably confirm the appraisal, evaluation index, and attribute information of the card 20 through the appraisal information, evaluation index information, and attribute information of the card 20 and NFT ownership information, which is shown in the NFT 400. The purchaser can also confirm that he/she has a co-ownership interest in the card 20. Furthermore, an investor who trades the NFT 400 on an exchange operated by the appraiser 6 can reliably confirm the appraisal, evaluation index, and attribute information of the card 20 through the appraisal information, evaluation index information, attribute information, and NFT ownership information, which is shown in the NFT 400. The investor can also confirm that the exchange (the appraiser 6) has co-ownership of the card 20. In this way, it is possible to adequately secure the safety of transactions of investment products that represent co-ownership interests in a tangible object.

In the variation of the present embodiment, each NFT 400 representing a co-ownership interest in the card 20 is sold to each user, and then each NFT 400 is bought and sold by an investor on the exchange, but the variation of the present embodiment is not limited thereto. For example, one NFT 400 representing the ownership of the card 20 may be sold to an entity operating the exchange, and then the entity holding the NFT 400 may electronically create co-ownership interests in the card 20 on a centralized database. In this case, the card 20 itself, which supports the value of the NFT 400, may be stored by the entity operating the exchange or by the appraiser 6. In the variation, the NFTs 400 with different token IDs are created, but the token ID of each of the NFTs 400 may be the same. In this case, the quantity of the NFTs 400 may be determined according to the quantity of co-ownership interests created for the card 20.

Although the disclosure and examples have been fully described with reference to the accompanying figures, it should be noted that various changes and variations will become apparent to persons skilled in the art. Such changes and variations are to be understood as being included within the scope of the disclosure and examples as defined by the appended claims.

Various aspects of the subject matter described herein are set out non-exhaustively in the following numbered clauses.

(1) An information processing device comprises:
one or more processors; and
a memory storing one or more programs configured to be executed by the one or more processors, the one or more programs including instructions for:
obtaining attribute information of a tangible object;
obtaining evaluation index information indicating one or more evaluation indexes of the tangible object;
obtaining appraisal information indicating an appraisal of the tangible object;
sending the evaluation index information, the appraisal information, and the attribute information to outside; and
broadcasting a creation request to a blockchain network to create a non-fungible token associated with the attribute information, the evaluation index information, and the appraisal information on a blockchain,
wherein:
the blockchain network is composed of a plurality of nodes each having the blockchain;
the non-fungible token is created on the blockchain; and
the appraisal information, the attribute information, and the evaluation index information is recorded as metadata for the non-fungible token.

(2) An information processing system comprises:
a blockchain network that is composed of a plurality of nodes each having a blockchain;
an appraiser device that is communicatively connected to the blockchain network and associated with an appraiser that appraises a tangible object;
a first device that is communicatively connected to the blockchain network and associated with a first user,
wherein the information processing system is configured to:
obtain image data showing the tangible object;
obtain attribute information of the tangible object;
obtain evaluation index information indicating one or more evaluation indexes of the tangible object;
obtain appraisal information indicating an appraisal of the tangible object;
send the image data, the evaluation index information, the appraisal information, and the attribute information to outside;
broadcast a creation request from the appraiser device to the blockchain network to create a non-fungible token on the blockchain, wherein the non-fungible token is associated with the image data, the attribute information, the evaluation index information, and the appraisal information;
create the non-fungible token on the blockchain in response to the creation request;
broadcast a change request from the appraiser device to the blockchain network to change an owner of the non-fungible token from the appraiser to the first user;
record information indicating that the owner of the non-fungible token is the first user on the blockchain in response to the change request;
send token identification information to identify the non-fungible token from the first device to the blockchain network;
send information related to the tangible object to the first device based on the token identification information;
broadcast a second change request from the first device to the blockchain network to change the owner of the non-fungible token from the first user to a second user; and
record information indicating that the owner of the non-fungible token is the second user on the blockchain in response to the second change request,
wherein an address of the image data, the appraisal information, the attribute information, and the evaluation index information is recorded as metadata of the non-fungible token.

What is claimed is:

1. An information processing method implemented by a computer, the method comprising:
obtaining attribute information of a tangible object;
obtaining appraisal information indicating an appraisal of the tangible object;
sending the appraisal information and the attribute information to outside; and
broadcasting a creation request to a blockchain network to create a non-fungible token associated with the attribute information and the appraisal information on a blockchain,
wherein
the blockchain network is composed of a plurality of nodes each having the blockchain,
the non-fungible token is created on the blockchain, and
the appraisal information and the attribute information is recorded as metadata for the non-fungible token.

2. The information processing method according to claim 1, further comprising:
obtaining evaluation index information indicating one or more evaluation indexes of the tangible object; and
sending the evaluation index information to outside,
wherein the evaluation index information is recorded as metadata for the non-fungible token.

3. The information processing method according to claim 2 further comprising:
obtaining image data showing the tangible object, and
wherein the obtaining the evaluation index information comprises obtaining the evaluation index information based on the obtained image data.

4. The information processing method according to claim 3, wherein
the obtaining the attribute information comprises obtaining the attribute information based on the obtained image data.

5. The information processing method according to claim 2, wherein
the obtaining the attribute information comprises obtaining the attribute information in response to an input operation by an operator, and
the obtaining the evaluation index information comprises obtaining the evaluation index information in response to the input operation.

6. The information processing method according to claim 1, wherein
the tangible object is a collectible.

7. The information processing method according to claim 1, wherein
the tangible object is a trading card.

8. The information processing method according to claim 1, wherein
the appraisal information includes grade information indicating a grade of the tangible object.

9. The information processing method according to claim 2, wherein
the evaluation index information indicates one or more evaluation indexes indicating a state of preservation of the tangible object and one or more evaluation indexes indicating an initial state of the tangible object.

10. The information processing method according to claim 1, wherein
the appraisal and attribute information is recorded on the blockchain.

11. The information processing method according to claim 1, further comprising:
broadcasting a change request to the blockchain network to change an owner of the non-fungible token from an appraiser who requested creation of the non-fungible token to a first user who has an ownership of the tangible object.

12. The information processing method according to claim 1, wherein
the non-fungible token has a plurality of non-fungible tokens,
each of the plurality of non-fungible tokens is associated with the appraisal information and the attribute information, and
each of the plurality of non-fungible tokens represents a co-ownership interest in the tangible object,
the information processing method further comprising:
broadcasting a change request to the blockchain network to change owners of the plurality of non-fungible tokens from an appraiser who requested creation of the plurality of non-fungible tokens to a plurality of users who have a co-ownership of the tangible object.

13. The information processing method according to claim 1, further comprising:
generating a wallet address for an appraiser who requested creation of the non-fungible token, based on a public key associated with a public digital certificate, wherein the public digital certificate is associated with the appraiser.

14. An information processing system comprising:
a blockchain network that is composed of a plurality of nodes each having a blockchain; and
an appraiser device that is communicably connected to the blockchain network and associated with an appraiser that appraises a tangible object,
wherein the information processing system is configured to:
obtain attribute information of the tangible object;
obtain appraisal information indicating an appraisal of the tangible object;
send the appraisal information and the attribute information to outside;
broadcast a creation request to the blockchain network to create a non-fungible token associated with the attribute information and the appraisal information on the blockchain; and
create the non-fungible token on the blockchain in response to the creation request,
wherein the appraisal information and the attribute information is recorded as metadata for the non-fungible token.

15. The information processing system according to claim 14, wherein
the information processing system is further configured to:
obtain evaluation index information indicating one or more evaluation indexes of the tangible object; and
send the evaluation index information to outside,
wherein the evaluation index information is recorded as metadata for the non-fungible token.

16. The information processing system according to claim 14, wherein
the information processing system is further configured to:
broadcast a change request to the blockchain network to change an owner of the non-fungible token from the appraiser to a first user who has an ownership of the tangible object;
record information indicating that the owner of the non-fungible token is the first user on the blockchain in response to the change request.

17. The information processing system according to claim 14, further comprising:
a first device communicatively connected to the blockchain network and associated with the first user who has the ownership of the tangible object,
wherein the information processing system is further configured to:
send token identification information to identify the non-fungible token from the first device to the blockchain network; and
send information indicating the owner of the non-fungible token, the appraisal information, and the attribute information to the first device, based on the token identification information.

18. The information processing system according to claim 17, wherein
the information processing system is further configured to:
broadcast a second change request from the first device to the blockchain network to change the owner of the non-fungible token from the first user to the second user; and
record information indicating that the owner of the non-fungible token is the second user on the blockchain in response to the second change request.

19. A protective case for a collectible, configured to house the collectible,
wherein a two-dimensional code is provided on the protective case to indicate information about a non-fungible token associated with the collectible,
wherein the non-fungible token is associated with:
attribute information of the collectible; and
appraisal information indicating an appraisal of the collectible,
wherein the attribute information and the appraisal information is recorded as metadata for the non-fungible token.
